(19) United States
(12) Patent Application Publication
(10) Pub. No.: US 2013/0156954 A1
(43) Pub. Date: Jun. 20, 2013

(54) ROLLER MAKING SYSTEM AND METHOD

(71) Applicant: CHIA-LING HSU, Tu-Cheng (TW)

(72) Inventor: CHIA-LING HSU, Tu-Cheng (TW)

(73) Assignee: HON HAI PRECISION INDUSTRY CO., LTD., Tu-Cheng (TW)

(21) Appl. No.: 13/456,242

(22) Filed: Apr. 26, 2012

(30) Foreign Application Priority Data
Dec. 19, 2011 (TW) 100146994

(51) Int. Cl. B05D 3/12; B05D 5/00; B05C 11/00

(52) U.S. Cl. 427/277; 118/102; 427/256

(57) ABSTRACT

The present disclosure provides a roller making system for making a roller with a plurality of microstructures. The roller making system includes a coating unit to coat molten Ethylene Tetrafluoroethylene (ETFE) material onto a lateral surface of a cylindrical workpiece, to obtain a semi-finished roller with an uniform ETFE layer after the molten ETFE material is solidified, and a microstructure forming unit to machine the ETFE layer of the semi-finished roller, to form the plurality of microstructures in the ETFE layer, thereby making a finished roller with the plurality of microstructures.

### BACKGROUND

1. Technical Field

The present disclosure relates to rollers which are used to form microstructures in brightness enhancement films of backlight modules of liquid crystal displays, and particularly, to a roller making system and a method thereof.

2. Description of Related Art

Metallic rollers are used to form microstructures in a brightness enhancement film of a backlight module of a liquid crystal display (LCD) device. However, the strong agglutination between the metallic roller and the film has negative effect to the forming of the microstructures. Moreover, microstructures on the metallic rollers tend to be scraped, which limits the repeated use of the rollers.

### BRIEF DESCRIPTION OF THE DRAWINGS

The components in the drawings are not necessarily drawn to scale, the emphasis instead being placed upon clearly illustrating the principles of the present disclose. Moreover, in the drawings, like reference numerals designate corresponding parts throughout the several views.

FIG. 1 is a block diagram of a roller making system in accordance with an exemplary embodiment.

FIG. 2 is an isometric view showing a cylindrical workpiece, a lateral surface of which has been coated with Ethylene Tetrafluoroethylene, in accordance with an exemplary embodiment.

FIG. 3 is an isometric view showing a machined roller after the cylindrical workpiece of FIG. 2 has been processed.

FIG. 4 is a flowchart of a method to make a roller in accordance with an exemplary embodiment.

### DETAILED DESCRIPTION

The disclosure is illustrated by way of example and not by way of limitation. It should be noted that references to “an” or “one” embodiment in this disclosure are not necessarily to the same embodiment, and such references mean at least one.

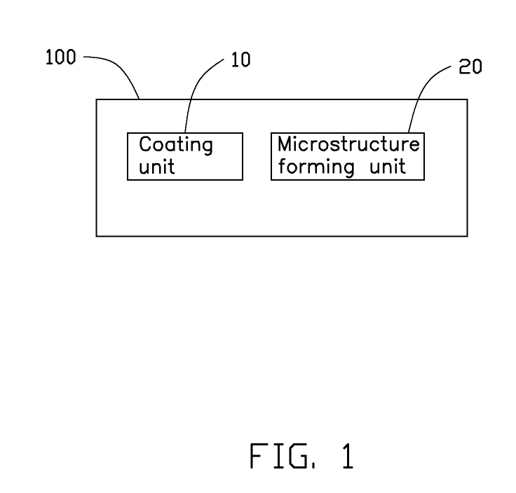

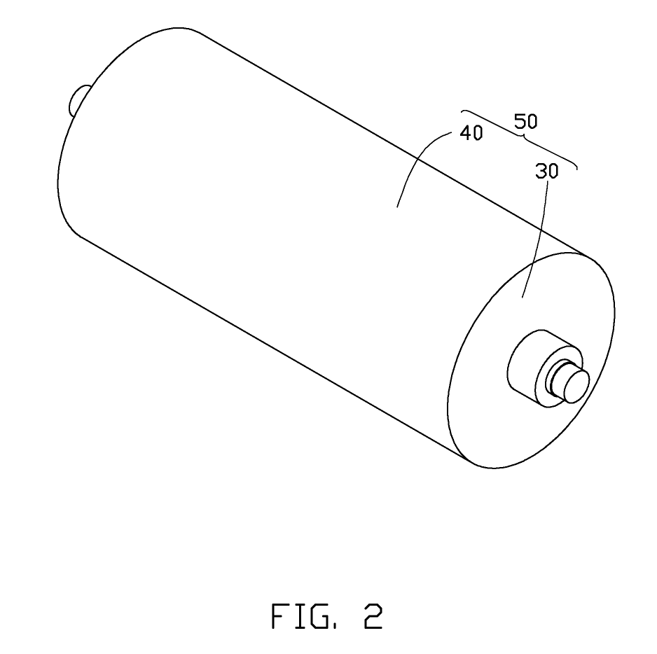

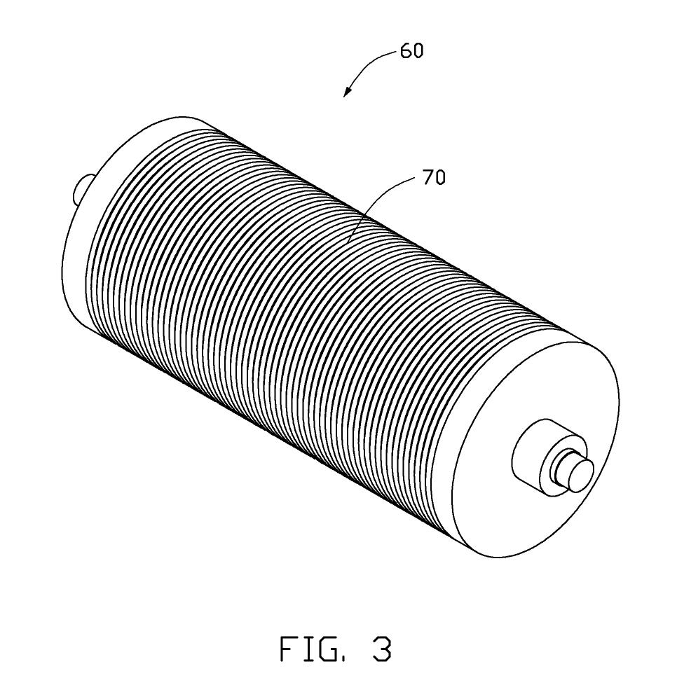

FIGS. 1-3 provide a roller making system 100 including a coating unit 10 and a microstructure forming unit 20. The system 100 can create a microstructure layer on a cylindrical workpiece 30 to make a roller 60 that is used to form microstructures in a brightness enhancement film (BEF) of a backlight module of an LCD display device.

The coating unit 10 coats molten Ethylene Tetrafluoroethylene (ETFE) material onto a lateral surface of the workpiece 30, to obtain a semi-finished roller 50 with an uniform ETFE layer 40 after the molten ETFE material is solidified. In the embodiment, the workpiece 30 is substantially metallic, such as copper, iron, stainless steel, or the like. The coating unit 10 may be a machine with a scraper, and the machine controls the scraper to coat the ETFE material onto the lateral surface of the workpiece 30. In the embodiment, the coating unit 10 is a slot die coating device. The temperature of the molten ETFE material 40 is generally maintained between about 240 degrees and about 260 degrees.

The microstructure forming unit 20 machines the ETFT layer 40 on the lateral surface of the semi-finished roller 50, to form a number of microstructures 70 in the ETFT layer 40, thereby making a roller 60 with the number of microstructures 70. In the embodiment, the microstructures 70 are a number of screwed threads coiling around the semi-finished roller 50 in parallel. The distance between any two adjacent threads is about 10 microns to 25 microns.

The microstructures 70 can be formed in different manners. For example, the microstructure forming unit 20 may machine the ETFT layer 40 with ultra-precision technology to form the microstructures 70. The microstructure forming unit 20 may be a metal roller 60 with a number of protruding teeth on its lateral surface, and can create microstructures 70 in the ETFT layer 40 by hot stamping. Specifically, the metal roller 60 and the semi-finished roller 50 are both heated to about 200 degrees, and rotated against each other. During the rotation, a number of microstructures 70 are formed on the lateral surface of the semi-finished roller 50 by the protruding teeth of the roller 60.

Because the Ethylene Tetrafluoroethylene material has a certain intensity and has little agglutination with the brightness enhancement film of a backlight module of an LCD, when the roller 60 machines microstructures of a brightness enhancement film, the roller 60 and the film can be easily separated, and the roller 60 is not easily damaged.

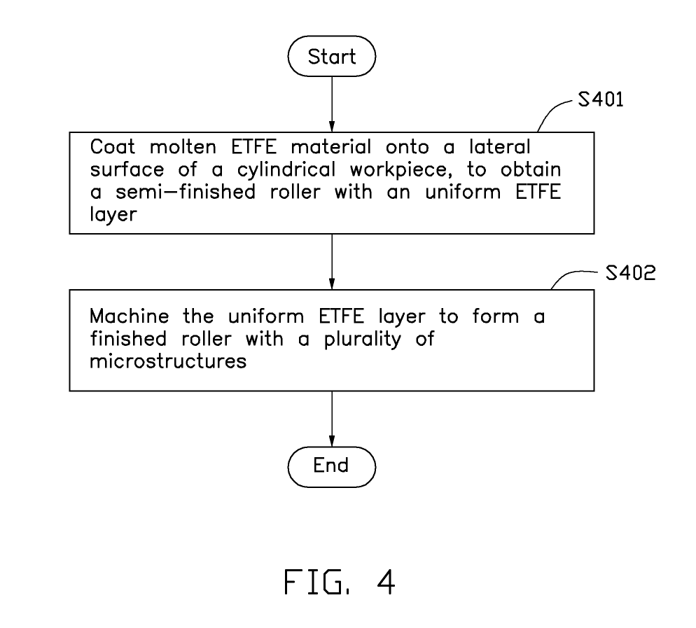

Referring to FIG. 4, a flowchart of a method to make the roller 60 in accordance with an exemplary embodiment is disclosed.

In step S401, the coating unit 10 is controlled to coat molten ETFE material onto a lateral surface of the workpiece 30, thereby obtaining a semi-finished roller 50 with an uniform ETFE layer 40 after the molten ETFE material is solidified.

In step S402, the microstructure forming unit 20 is controlled to machine the ETFT layer 40 of the semi-finished roller 50, forming a number of microstructures 70 in the ETFT layer 40, thereby making the roller 60 with the number of microstructures 70.

In step 402, the microstructure forming unit 20 may be a roller 60 with a number of protruding teeth on its lateral surface, and can create microstructures 70 in the ETFT layer 40 by hot stamping.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A roller making system for making a roller with a plurality of microstructures, the roller making system comprising:
a coating unit to coat molten Ethylene Tetrafluoroethylene (ETFE) material onto a lateral surface of a cylindrical workpiece, to obtain a semi-finished roller with an uniform ETFE layer after the molten ETFE material is solidified; and
a microstructure forming unit to machine the ETFE layer of the semi-finished roller, to form the plurality of microstructures in the ETFE layer, thereby making a finished roller with the plurality of microstructures.

2. The roller making system as described in claim 1, wherein the coating unit is a machine with a scraper, and the machine controls the scraper to coat the molten ETFE material onto the lateral surface of the workpiece.

3. The roller making system as described in claim 1, wherein the coating unit is a Slot Die coating device.

4. The roller making system as described in claim 1, wherein the microstructure forming unit machines the uniform ETFE layer with ultra-precision technology to form the plurality of microstructures.

5. The roller making system as described in claim 1, wherein the microstructure forming unit is a roller with a plurality of protruding teeth on its lateral surface, and creates the plurality of microstructures in the ETFT layer by hot stamping.

6. The roller making system as described in claim 5, wherein the microstructure forming unit and the semi-finished roller are both heated to approximate to 200 degrees.

7. The roller making system as described in claim 1, wherein the temperature of the molten ETFE material is maintained between 240 degrees and 260 degrees.

8. A method for making a roller with a plurality of microstructures, the making method comprising:
coat molten Ethylene Tetrafluoroethylene (ETFE) material onto a lateral surface of a cylindrical workpiece, to obtain a semi-finished roller with an uniform ETFE layer after the molten ETFE material is solidified; and
machine the uniform ETFE layer of the semi-finished roller, to form the plurality of microstructures in the ETFE layer, thereby making a finished roller with the plurality of microstructures.

9. The method as described in claim 8, wherein the machining step comprising:
create the plurality of microstructures in the ETFT layer by hot stamping.
